(19) United States
(12) Patent Application Publication
(10) Pub. No.: US 2024/0313606 A1
(43) Pub. Date: Sep. 19, 2024

(54) DRIVE UNIT WITH COUPLING UNIT

(71) Applicant: Dr. Fritz Faulhaber GmbH & Co. KG, Schönaich (DE)

(72) Inventor: James Russell RITTER, III, Clearwater, FL (US)

(21) Appl. No.: 18/121,098

(22) Filed: Mar. 14, 2023

(51) Int. Cl. H02K 5/00; H02K 7/00; H02K 7/116

(52) U.S. Cl. CPC H02K 5/00; H02K 7/003; H02K 7/116

(57) ABSTRACT

A drive unit comprising at least one motor, at least one drive shaft, and at least one coupling unit. The coupling unit comprises at least one rotor element rotatable with the drive shaft, at least one receiving element, at least one first coupling body, and at least one second coupling body. The first coupling body is arranged on the rotor element such that at least a radial position of the first coupling body on the rotor element is changeable at least during rotation, wherein the second coupling body is arranged on the receiving element. The first coupling body and the second coupling body are designed for magnetic interaction, so that the first coupling body and the second coupling body can magnetically interact at at least one predetermined radial position of the first coupling body on the rotor element for transmitting a force from the rotor element to the receiving element.

### FIELD

The invention relates to a drive unit with at least one motor, at least one drive shaft and at least one coupling unit. The coupling unit is in particular connected to the drive shaft.

### BACKGROUND

Drive units with coupling units are known in the state of the art in a variety of designs. Coupling units are used, for example, to couple the motor to loads or other drive components or to separate the motor therefrom. In a special embodiment, a coupling unit can also serve to brake a motor. Furthermore, coupling units can serve to protect the motor from overload or damage due to sudden loads or vibrations by acting as a buffer zone between the motor and further drive components.

Known coupling units often have the disadvantage that they require actively controlled components for the actuation of the coupling unit, which increase the effort for the manufacturing and its costs.

The invention is therefore based on the object of specifying a drive unit for which the manufacturing effort is low and the manufacturing costs are reduced.

### SUMMARY

The aforementioned object is solved with a drive unit described and claimed in the claims. The drive unit has at least one motor, at least one drive shaft and at least one coupling unit. The coupling unit is advantageously connected to the drive shaft. The coupling unit comprises at least one rotor element, at least one receiving element, at least one first coupling body and at least one second coupling body. Preferably, it is provided that the rotor element is formed as a rotor disc. The rotor disc may also be referred to, for example, as a reluctance disc. Advantageously, it is provided that the receiving element is formed as a receiving disk. In particular, the rotor element is connected to the drive shaft in a rotationally fixed manner. For example, the rotor element is bonded or welded to the drive shaft.

When the drive shaft rotates, the rotor element also rotates. The first coupling body is arranged on the rotor element in such a way that a radial position of the first coupling body on the rotor element can be changed during rotation, i.e. during operation. In particular, the radial position is a radial distance of the first coupling body to a longitudinal axis of the drive shaft or to the drive shaft. In particular, by changing the position, a path with which the first coupling body moves about the longitudinal axis can be changed. Preferably, it is provided that the position or the distance of the first coupling body to the drive shaft can be changed in dependence on the rotational speed of the rotor element or the drive shaft. In particular, the first coupling body is held on the rotor element in such a way that the radial position or distance changes as a function of the rotational speed. For example, the position or the distance changes as a function of at least one rotational speed threshold value. Because the position can be changed as a function of the rotational speed, automatic coupling and decoupling of the coupling unit can also be performed as a function of the rotational speed.

The second coupling body is preferably arranged on the receiving element in such a way that the second coupling body has a fixed radial position on the receiving element. In particular, the second coupling body has a fixed radial distance to the drive shaft or to a longitudinal axis of the drive shaft. This means that the radial position, in particular the distance, of the second coupling body on the receiving element cannot be changed during rotation. In particular, the second coupling body moves along a fixed path determined by the position on the receiving element. In particular, the radial distance of the coupling body from the drive shaft is not changeable, but is fixed by the position in the receiving element. This understanding is also intended to include that the second coupling body moves, for example, along an elliptical path, the course of which is not changeable, but in which the distance of the second coupling body from the longitudinal axis changes along a fixed path during rotation. The rotor element and the receiving element are advantageously arranged adjacent to each other in the axial direction along the longitudinal axis.

The first coupling body and the second coupling body are configured to magnetically interact, i.e., the first coupling body and the second coupling body magnetically attract each other. For example, it is provided that the first coupling body comprises a ferromagnetic material and the second coupling body comprises a permanent magnetic material. This allows the first coupling body and the second coupling body to interact magnetically. It is particularly preferred that the first coupling body consists of a ferromagnetic material and/or that the second coupling body consists of a permanent magnetic material. The second coupling body is in particular a permanent magnet.

Alternatively, it is provided that the first coupling body comprises a permanent magnetic material and the second coupling body comprises a ferromagnetic material, in particular that the first coupling body consists of a permanent magnetic material and the second coupling body consists of a ferromagnetic material. It is also provided that the first and second coupling bodies comprise a magnetic material or consist of a magnetic material, in particular are formed as permanent magnets.

As a result, the first coupling body and the second coupling body can magnetically interact and transmit a force from the rotor element to the receiving element at least when the first coupling body is at at least one predetermined radial position. In particular, according to a further embodiment, the interaction can occur when the radial distance of the first coupling body from the longitudinal axis during rotation corresponds to the radial distance of the second coupling body from the longitudinal axis.

Coupling of the coupling unit takes place by magnetic interaction of the first coupling body and the second coupling body. If the first coupling body and the second coupling body do not interact magnetically, the coupling unit is decoupled. Consequently, if in particular at least the radial distance of the first coupling body to the drive shaft is changed during operation, a force transmission between the rotor element and the receiving element occurs precisely at the time when the first coupling body and the second coupling body are arranged at a matching radial distance. The first coupling body attracts the second coupling body or the second coupling body attracts the first coupling body, resulting in a force transmission from the rotor element to the receiving element.

Advantageously, interaction between the first coupling body and the second coupling body occurs at the time when the first coupling body is at least partially in contact with the receiving element. In embodiments in which the coupling body can move in a radial direction towards and away from the receiving element in order to change its radial position or radial distance, interaction occurs at the time when the first coupling body is at the smallest radius that it can constructively achieve, in particular at the time when it rests against the receiving element.

The coupling unit is advantageously designed as a magnetic coupling. In particular, the coupling unit is bidirectional, so that it functions independently of the direction of rotation of the drive shaft, i.e. in both directions of rotation of the drive shaft.

Compared with the prior art, the invention has the advantage that the coupling unit is easy to assemble and can be manufactured at low cost. In addition, the coupling unit is advantageously designed to be passive, so that it automatically activates or deactivates a force transmission, i.e. couples or decouples the coupling unit, without any external action being required.

According to a particularly preferred embodiment, it is provided that the receiving element is held in a rotationally fixed manner, in particular is held in a rotationally fixed manner relative to a housing of the motor. This way the coupling unit can be used as a brake, since the rotor element is braked after the motor is switched off or in the event of a power failure when a force is transmitted to the receiving element as a result of the interaction of the first and second coupling body. Advantageously, the coupling unit is set up and designed in such a way that interaction of the first and second coupling body takes place, in particular at speeds below a first speed threshold value, for example below 5,000 or 3,500 revolutions per minute. This design advantageously implements a passive brake for the motor.

Alternatively, it is provided that the receiving element is held rotatably about the longitudinal axis of the drive shaft so that the coupling unit can be used as a clutch, in particular for transmitting a torque. When the first coupling body and the second coupling body interact magnetically at a common distance from the longitudinal axis or a predetermined position of the first coupling body, and the transmission of force takes place, the rotating rotor element sets the receiving element in rotation. In particular, when the rotational speed of the drive shaft exceeds a first threshold value and/or a load on a shaft of the receiving element becomes too great, decoupling of the coupling unit occurs. The coupling unit can advantageously be used as a clutch.

According to an embodiment of the drive unit, it is provided in particular that the drive shaft is a motor shaft of the motor, so that the rotor element is directly attached to the motor shaft. This is the particularly preferred variant. Alternatively, it is provided that the drive unit comprises at least a gearbox, that the gearbox is coupled to a motor shaft of the motor, and that the gearbox comprises the drive shaft to which the rotor element is connected. Preferably, the rotor element is connected to an output shaft of the gearbox.

In particular, in order to be able to advantageously change or increase the forces or torque that can be transmitted from the rotor element to the receiving element. it is provided according to a further embodiment that a plurality of first coupling bodies is arranged on the rotor element in such a way that the respective radial position of each first coupling body can be changed during rotation, in particular as a function of the rotational speed. Preferably, the respective radial distance of the first coupling bodies to the longitudinal axis of the drive shaft is variable.

For example, it is provided that at least or exactly two, at least or exactly three, at least or exactly four, at least or exactly five, or at least or exactly six first coupling bodies are arranged on the rotor element. The radial position or the radial distance of each first coupling body to the drive shaft or to a longitudinal axis of the drive shaft is variable or changeable at least during the rotation of the rotor element. In particular, the distance of all first coupling bodies on the rotor element is changeable as a function of the rotational speed or of the centrifugal force acting on the first coupling bodies. With a plurality of first coupling bodies, each first coupling body can interact magnetically with each second coupling body and vice versa.

The first coupling bodies are preferably arranged uniformly spaced apart from one another on a circumference of the rotor element. Preferably, it is provided that at least the radial position or the radial distance of all first coupling bodies is changed identically. Furthermore, it is preferably provided that all first coupling bodies have a matching minimum and maximum distance from the drive shaft.

According to a further embodiment of the drive unit, it is provided that a plurality of second coupling bodies is arranged on the receiving element. Preferably, the number of second coupling bodies corresponds to the number of first coupling bodies on the rotor element. However, it is also provided that the number of second coupling bodies is less than or greater than the number of the first coupling bodies. Preferably. the receiving element has at least or exactly two, at least or exactly three, at least or exactly four, at least or exactly five, or at least or exactly six second coupling bodies.

The second coupling bodies are arranged on the receiving element, for example, in such a way that they have a common fixed radial distance from the longitudinal axis. All second coupling bodies therefore each have the same distance to the longitudinal axis of the drive shaft. The second coupling bodies are preferably arranged uniformly spaced apart on the circumference of the receiving element.

Alternatively, it is provided that the second coupling bodies have different, but during rotation unchangeable, radial positions or distances to the drive shaft. For example, half of the second coupling bodies have a first radial distance to the drive shaft and a second half of the second coupling bodies have a second radial distance to the drive shaft. For example, it is provided that the second coupling bodies circumferentially each have a first radial distance and a second radial distance alternately. By means of the different radial distances, the force transmission between the rotor element and the receiving element can be changed or adjusted.

Furthermore, it is also provided, for example, that the second coupling bodies move at their respective radial position, in particular off-center, in an elliptical path around the longitudinal axis. Depending on the rotation, different distances from the longitudinal axis are thereby taken, but the position of the second coupling bodies and thus their path along which they move about the longitudinal axis is not changed. In particular, the position at the receiving body remains the same, while the position at the rotor element for the first coupling bodies can be changed.

According to a further embodiment, it has been found to be particularly advantageous if it is provided that the rotor element has at least one first receiving space, and that the first coupling body is arranged in the first receiving space such that it can be moved in the radial and/or axial direction. Preferably, the receiving space is configured such that the coupling body is movable in radial and axial direction. However, it is particularly provided that the receiving space is designed in such a way that movement can only take place in the axial direction.

Preferably, a number of first receiving spaces is provided in the rotor element that corresponds to the number of first coupling bodies. For example, the receiving spaces are evenly spaced apart on a circumference of the rotor element. Preferably, a first coupling body can move freely in a first receiving space. Depending on the rotational speed of the rotor element, the first coupling body in the first receiving space is moved, for example, in the direction of greater distances from the longitudinal axis.

Preferably, it is provided that a radial height of the receiving space corresponds to at least about 1.5 to 2 times the diameter of a first coupling body if the coupling body is designed as a sphere, for example. For example, an axial extent of the receiving space corresponds to about 1.2 to 1.5 times the diameter of a spherical first coupling body.

Preferably, the rotor element has at least or exactly two, at least or exactly three, at least or exactly four, at least or exactly five, or at least or exactly six first receiving spaces. For example, it is provided that the receiving spaces, aligned with the longitudinal axis, extend in the radial direction and have a cylindrical cross-section.

According to a further embodiment of the drive unit. it is provided that the first receiving space has at least one opening at least in the direction of the receiving element and/or in the direction of the longitudinal axis, so that the first coupling body at least partially abuts against a surface of the receiving element when the first coupling body and the second coupling body interact magnetically. Depending on the further development of the drive unit, it is provided that the first coupling body abuts against a surface aligned orthogonally to the longitudinal axis, or that the first coupling body abuts against an outer circumferential surface of the receiving element, in particular against an outer circumferential surface of the receiving element.

According to a further embodiment, it has turned out to be particularly advantageous if it is provided that the surface of the receiving element, in particular in axial extension of at least the second coupling body, has at least one projection and/or at least one recess for interaction with the first coupling body. For example, the recess is formed as a cutout or aperture in the surface of the receiving element. Preferably, the recess is formed such that it corresponds to an outer contour of the first coupling body. for example a recess having a fixed radius.

Alternatively or in addition to this, at least one projection is formed on the receiving element in the surface, in particular in axial extension of the second coupling body. The projection is formed, for example, as an edge, corrugation and/or other elevation. The projection and/or recess enables positive or frictional interaction of the first coupling body with the surface of the receiving element in order to improve the transmission of force during magnetic interaction of the first coupling body with the second coupling body. Depending on the embodiment of the drive unit, the protrusion and/or recess is provided in a surface of the receiving element oriented orthogonally to the longitudinal axis or in an outer circumferential surface.

The recess and/or protrusion is preferably arranged at a distance from the longitudinal axis at which the first coupling body is arranged for magnetic interaction with the second coupling body. Further alternatively, the surface is substantially smooth.

In particular, in order to ensure that the first coupling body is arranged spaced apart from the receiving element or the surface of the receiving element in the uncoupled state of the coupling unit, according to a further embodiment of the drive unit it is provided that a cross section of the first receiving space decreases in a direction parallel to a longitudinal axis of the drive shaft in the direction of the receiving element. For this purpose, for example, the walls of the receiving space running parallel to the longitudinal axis of the drive shaft are aligned at an angle to the longitudinal axis so that they move towards each other in the direction of the receiving element. This ensures, in particular, that the first coupling body is at a distance from the receiving element when the coupling unit is decoupled. Due to the inclination of the surfaces, a first coupling body, in particular formed as a sphere, moves away from the receiving element due to the inclined walls.

According to a further embodiment of the drive unit, it has been found to be further advantageous if it is provided that the first receiving space has a substantially drop-shaped cross section orthogonal to a longitudinal axis of the drive shaft, and that the receiving space is arranged in such a way that the cross section tapers in the direction of the longitudinal axis. The possibly only imaginary tip of the drop-shaped cross-section is preferably aligned in the direction of the longitudinal axis of the drive shaft. For example, the cross-section does not have a tip, but has a radius in the narrowest cross-section, preferably a radius substantially corresponding to a radius of a spherical first coupling body. This allows the first coupling body to preferably be arranged in the tapered portion of the cross-section when the first coupling body magnetically interacts with the second coupling body. Due to the cross-section of the receiving space widening radially in the direction of greater distances from the longitudinal axis, the first coupling body, in particular if it is formed as a sphere, can advantageously move away from the second coupling body during rotation.

A further embodiment of the drive unit provides that the drop-shaped cross-section has two flanks converging towards each other, and that each of these flanks is arranged at an angle a to a radial to the longitudinal axis, in particular to a radial that is a tangent to the cross-section. Consequently, the flanks are not inclined in such a way that their imaginary extensions cross on the longitudinal axis, or the flanks do not run parallel to a radial to the longitudinal axis. The flanks preferably have a flank angle between 1° and 15° to a radial. Preferably, the angle is between 3° and 10°, in particular between 5° and 8°. Such an alignment of the flanks facilitates movement of the first coupling body at lower speeds.

According to a further embodiment, it has turned out to be particularly advantageous if the first coupling body is formed as a sphere or rod-shaped. A coupling body formed as a sphere can advantageously move in a receiving space of the rotor element in order to interact with the second coupling body at low rotational speeds and to be arranged radially spaced apart from the second coupling body at high rotational speeds. A rod-shaped coupling body can advantageously be arranged in a cylindrical, first receiving space extending radially to the longitudinal axis.

With regard to the second coupling body, it has been found to be advantageous if it is formed rod-shaped and/or as a sphere. Preferably, the second coupling body is formed as a cylindrical rod.

A further embodiment of the drive unit provides that the receiving element has at least one second receiving space, and that the second receiving space is formed such that the second receiving space surrounds the second coupling body in a substantially form-fitting manner. Consequently, the second coupling body is form-fittingly held in the second receiving space so that the second coupling body has a fixed radial position, in particular a fixed radial distance from the longitudinal axis. For example, the second coupling body is fixed in the second receiving space in a force-fitting, material-fitting and/or form-fitting manner, for example clamped or bonded. The second receiving space is preferably formed cylindrically and extends radially to the longitudinal axis or parallel to the longitudinal axis.

Depending on the material of the first coupling body or the second coupling body, it is provided according to a further embodiment of the drive unit that the rotor element and/or the receiving element are made of a non-magnetic material. Preferably, it is provided that the receiving element is made of a thermoplastic polymer. in particular a thermoplastic copolymer. Preferably, the receiving element is made of Polyoxymethylene (POM). It is further preferred that the rotor element is made of a precipitation-hardened aluminum alloy, in particular EN-AW-6061. Preferably, the second coupling body is made of neodymium.

A further embodiment of the drive unit provides that the receiving element comprises at least one projection, and that the projection extends at least partially into the rotor element. For example, the receiving element has a disc-shaped base body with a cylindrical projection. The diameter of the projection is smaller than the diameter of the base body. In particular, the projection extends at least partially into the rotor element in the region of the longitudinal axis. For this purpose, the rotor element has a central recess.

In order to generate a reciprocation of the projection in relation to the rotor element, according to an embodiment, the projection is arranged off-center, in particular off-center on a base body. As a result, the projection reciprocates within the rotor element during rotation. This reciprocation favors a movement of the first coupling body or bodies, which rest on an outer circumference of the projection during a magnetic interaction and are alternately forced into the respective first receiving space by the reciprocation. Preferably, the second coupling bodies are arranged in the projection, in particular parallel to the longitudinal axis.

According to a particularly preferred embodiment, in which the coupling unit can be used as a brake, it is provided that the receiving element is arranged in a retainer housing, and that the retainer housing at least partially surrounds the rotor element. The retainer housing is preferably bonded or welded to the housing of the motor. Furthermore, the receiving element is fixed, for example glued, in the retainer housing.

The coupling forces of the coupling unit can be adjusted by the size and material of the first coupling body, the distance between the first coupling body and the second coupling body in the interacting state, the radial distance of the second coupling bodies, the size and material of the second coupling body and the geometry of the first receiving space.

The invention further relates to a coupling unit according to one of the described embodiments.

Whenever statements are made above or below concerning the design of a feature or component in the singular, these statements refer to each of these components or features—if there are a plurality of these components or features, unless otherwise indicated.

### BRIEF DESCRIPTION OF THE DRAWINGS

Further advantageous embodiments of the invention are apparent from the following description of the figures and the dependent claims when taken in conjunction with the accompanying drawings wherein:

FIG. 1 is an embodiment of a drive unit in perspective exploded view,

FIG. 2 is a sectional view of an embodiment of a drive unit according to

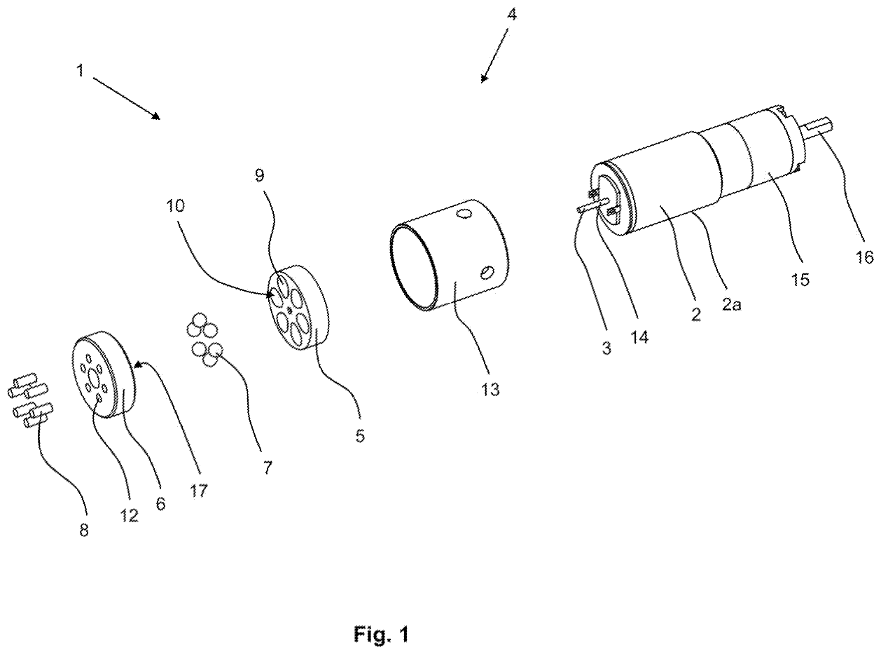

FIG. 1 in the decoupled state,

FIG. 3 is a sectional view of the embodiment of FIG. 1 in the coupled state,

FIG. 4a is the embodiment according to FIG. 1 in section through the receiving element,

FIG. 4b is the embodiment according to FIG. 1 in section through the receiving element,

FIG. 5 is a further embodiment of a drive unit in section,

FIG. 6 is an exploded perspective view of a further embodiment of a drive unit,

FIG. 7 is a sectional view of the embodiment of FIG. 6,

FIG. 8 is a section through the coupling unit according to FIG. 6 in the area of the rotor element, and

FIG. 9 is a side view of an embodiment of a receiving element according to FIG. 6.

### DETAILED DESCRIPTION

In the various figures in the drawing, the same parts are always given the same reference signs.

Regarding the following description, it is claimed that the invention is not limited to the embodiments and thereby not limited to all or several features of described feature combinations, rather each individual partial feature of the/each embodiment is also of importance for the subject matter of the invention detached from all other partial features described in connection therewith for itself and also in combination with any features of another embodiment.

FIG. 1 shows an embodiment of a drive unit 1 in perspective exploded view. The drive unit 1 has at least one motor 2, at least one drive shaft 3, and at least one coupling unit 4. In this embodiment, the drive shaft 3 is the motor shaft 14 of the motor 2. In this embodiment, the motor shaft 14 emerges from the housing 2a of the motor 2 on two opposite sides. In this embodiment, in addition to the coupling unit 4, a gearbox 15 having an output shaft 16 is arranged on the motor 2. The coupling unit 4 is arranged on the motor 2 opposite the gearbox 15. The coupling unit 4 has at least one rotor element 5 and at least one receiving element 6. Six first coupling bodies 7 are arranged on the rotor element 5 in this embodiment. Six second coupling bodies 8 are arranged on the receiving element 6.

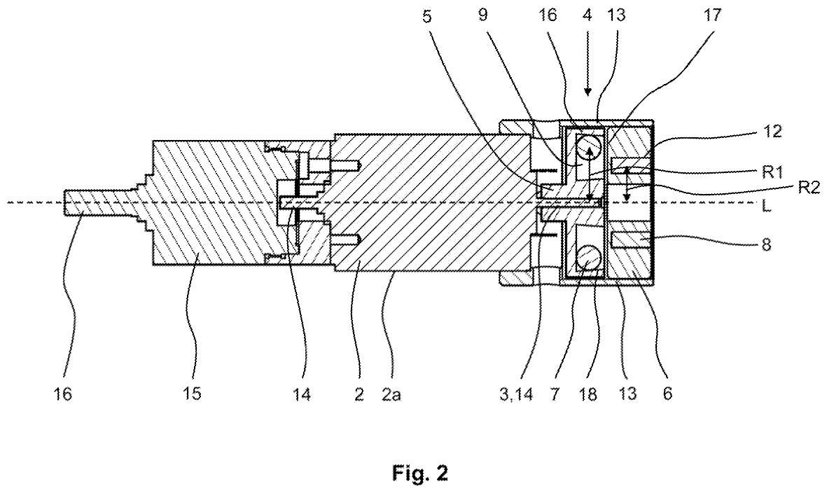

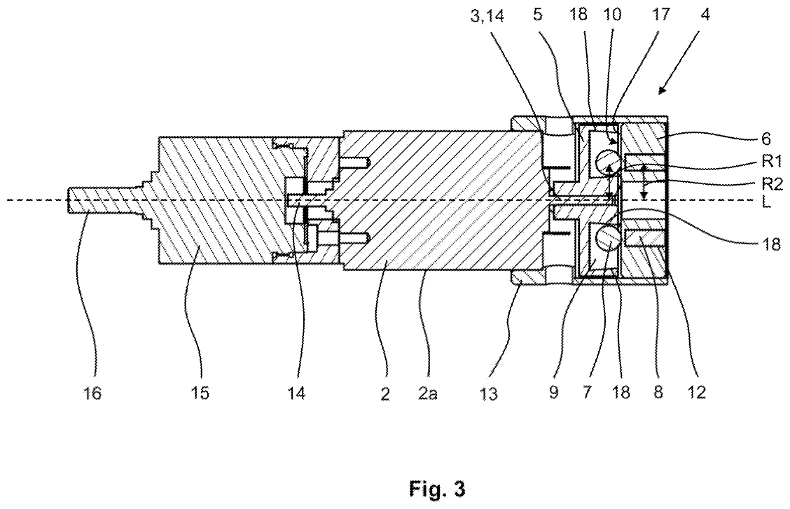

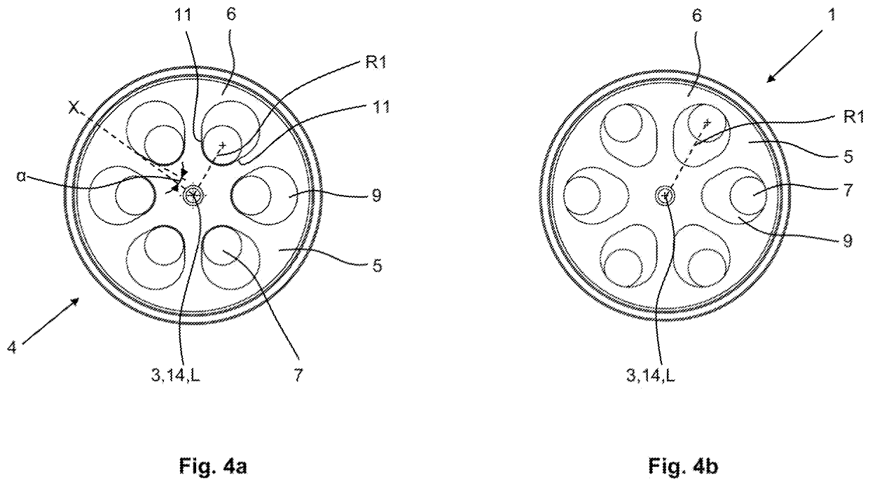

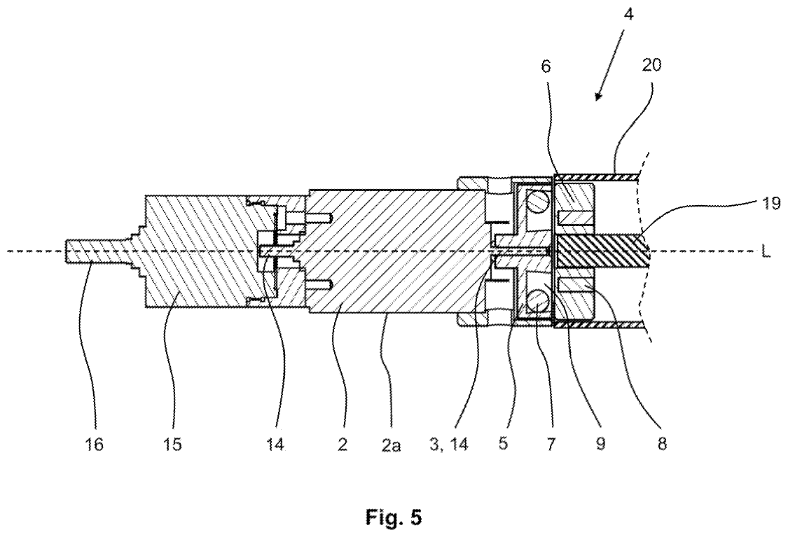

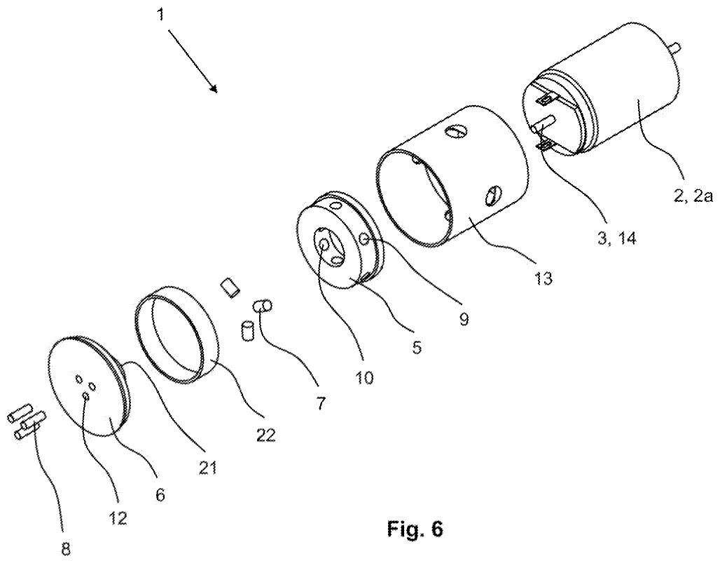

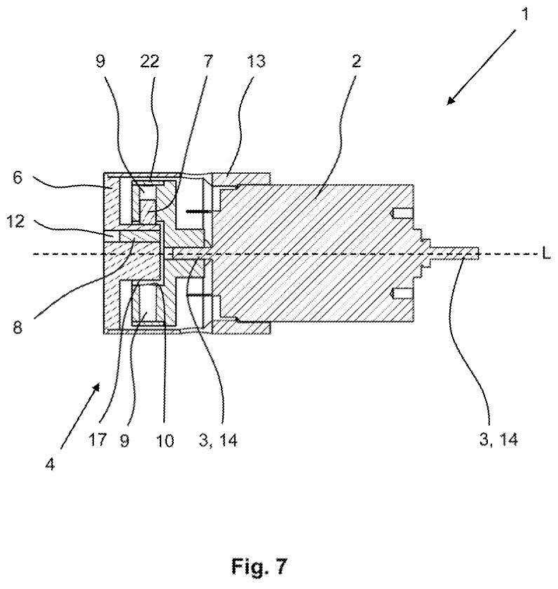

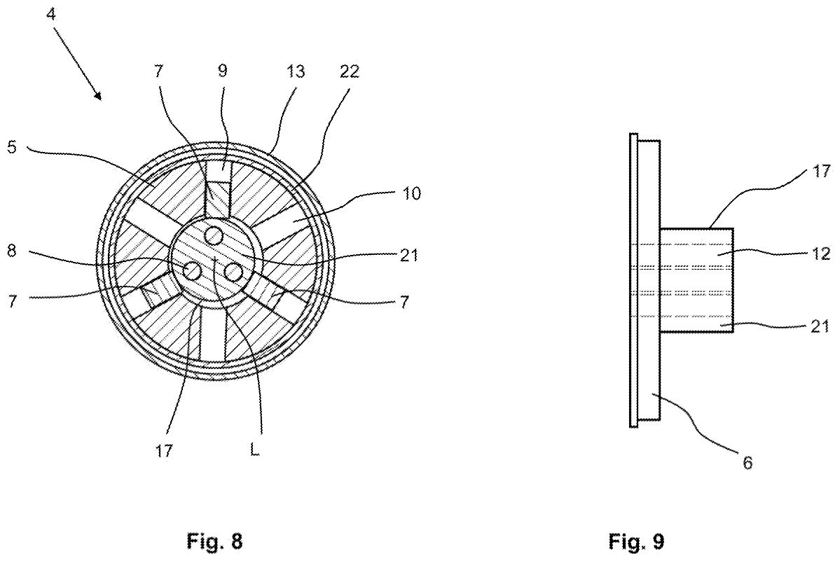

FIGS. 2 and 3 show an embodiment of a drive unit 1 in sectional view along the longitudinal axis L of the drive shaft 3. The motor 2 and the gearbox 15 are shown in section only schematically and not with their details. FIG. 2 shows the coupling unit 4 of the drive unit 1 in the decoupled state, so that the motor 2 or the drive shaft 3 can rotate freely. FIG. 3 shows the coupling unit 4 in the coupled state, so that the motor 2 or the drive shaft 3 is braked by the coupling unit 4.

FIG. 4a shows the embodiment according to FIG. 1 in section through the receiving element 6 in the coupled state of the coupling unit 4, namely in the state in which the first and second coupling bodies interact magnetically-see also FIG. 3. FIG. 4b shows the embodiment according to FIG. 1 in section through the receiving element 6 in the uncoupled state, i.e. during rotation at a speed sufficient to move the first coupling bodies 7 away from the longitudinal axis L.

According to FIGS. 1 to 4b, the rotor element 5 is rotatable with the drive shaft 3 in that the rotor element 5 is fixedly connected to the drive shaft 3. The first coupling bodies 7 are arranged on the rotor element 5 in such a way that a radial position, in particular a radial distance R1, of the first coupling body 7 relative to the longitudinal axis L of the drive shaft 3 can be changed at least during a rotation of the rotor element 5. The radial distance R1 of the first coupling bodies 7 from the longitudinal axis can be changed in that the first coupling bodies 7 are held in receiving spaces 9 within the rotor element 5. The receiving spaces 9 are designed in such a way that the first coupling bodies 7 can move in the radial direction as well as in the axial direction along the longitudinal axis L within the receiving spaces 9. In this embodiment, the first coupling bodies 7 are formed as balls made of a ferromagnetic material.

During operation of the drive unit 1, i.e. during a rotation of the motor 2 at operating speed, the first coupling bodies 7 within the receiving spaces 9 are pressed radially outward by the centrifugal force, as a result of which no magnetic interaction takes place between the first coupling bodies 7 and the second coupling bodies 8. The rotor element 5 can thus rotate freely and the motor 2 is not braked—see in particular FIG. 4b.

According to the embodiment of FIGS. 1 to 4b, six second coupling bodies 8 are arranged in an unchangeable position, in particular at a fixed radial distance R2 from the longitudinal axis L, in the receiving element 6. For this purpose, the receiving element 6 has six second receiving spaces 12 which enclose the second coupling bodies 8 in a form-fitting manner. The second coupling bodies 8 are designed as permanent magnets, so that the first coupling bodies 7 and the second coupling bodies 8 interact magnetically, in particular when the radial distance R1 corresponds to the radial distance R2. The second coupling bodies 8 are held in the receiving element 6 parallel to the longitudinal axis L.

FIG. 2 shows the decoupled coupling unit 4 when the drive shaft 3 is rotating at operating speed. If, starting from the state according to FIG. 2, the rotational speed of the motor 2 is reduced and the first coupling bodies 7 are no longer forced outward by the centrifugal force to a sufficient extent, the first coupling bodies 7 will move in the direction of the longitudinal axis L. When the rotational speed is low enough for the magnetic force of the second coupling bodies 8 to attract the first coupling bodies 7, the first coupling bodies 7 in the receiving spaces 9 move in the direction of the receiving element 6 and, due to the magnetic interaction with the second coupling bodies 8 and grinding on a surface 17, brake the rotor element 5 and thus the motor 2.

In the coupled state of the coupling unit 4 according to FIG. 3, the first coupling bodies 7 rest against the surface 17 of the receiving element 6. For this purpose, the receiving spaces 9 each have an opening 10. The distance R1 corresponds to the distance R2, so that an interaction can take place. The rotor element 5 is arranged directly adjacent to the receiving element 6. The receiving element 6 is held in a rotationally fixed manner in a retaining housing 13 which surrounds the rotor element 5 and is firmly connected, in this case bonded, to the housing 2a of the motor 2. The second coupling bodies 8 in the receiving element 6 have a fixed distance R2 from the drive shaft 3 or from the longitudinal axis L of the drive shaft 3.

According to FIGS. 2 and 3, the cross-section of the first receiving spaces 9 tapers in the direction of the receiving element 6 in a direction parallel to a longitudinal axis L of the drive shaft 3. This ensures in particular that the first coupling bodies 7 move away from the receiving element 6 during rotation according to FIG. 2 at the walls 18 of the receiving spaces 9 that are inclined relative to the longitudinal axis L, so that the rotor element 5 can rotate freely. Furthermore, the inclined walls 18 contribute to the reduction of lash in the coupled state according to FIG. 3.

According to FIG. 4a and FIG. 4b, the first receiving spaces 9 have a substantially drop-shaped cross section orthogonal to a longitudinal axis L of the drive shaft 3. The cross sections of the receiving spaces 9 are arranged in such a way that the cross section tapers in the direction of the longitudinal axis L. At the narrowest point, a radius is provided which corresponds to the radius of the spherical, first coupling bodies 7. The receiving spaces 9 are evenly distributed around the circumference of the receiving element 6. The drop-shaped cross-section of the receiving spaces 9 has respectively two flanks 11 tapering towards each other, between which the first coupling bodies 7 are held in the coupled state according to FIG. 4a. The flanks 11 have a flank angle a to a radial X, which here is about 7.5°. Consequently, the flanks 11 are arranged in such a way that they do not lie on a radial. This promotes a movement of the first coupling bodies 7 at low speeds away from the interaction with the second coupling bodies 8.

FIG. 4b shows the coupling unit 4 in the decoupled state, in which the first coupling bodies 7 are at a maximum radial distance R1 from the drive shaft 3 or the longitudinal axis L of the drive shaft 3, so that there is no magnetic interaction with the second coupling bodies 8 and the rotor element 5 can rotate freely.

FIG. 5 shows another embodiment of a drive unit 1 in a sectional view along the longitudinal axis L of the drive shaft 3. Here, too, the motor 2 and the gearbox 15 are shown only schematically. The function of the coupling unit 4 is essentially as described for the preceding embodiments, with the only difference being that the receiving element 6 is rotatably mounted on an output shaft 19 and is surrounded by a receiving housing 20. As a result of the fact that the receiving element 6 is rotatably mounted, a torque is transmitted from the rotor element 5 to the receiving element 6 in the coupled state. If the speed of the drive shaft 3 becomes too high or the load on the output shaft 19 increases too much, decoupling takes place and the first coupling bodies 7 move outward—as shown in FIG. 5. As an alternative to arranging the coupling unit 4 on the motor shaft 14 as the drive shaft 3, the coupling unit 4 could also be arranged on the output shaft 16 of the gearbox 15.

FIGS. 6 to 8 show a further, alternative embodiment of a drive unit 1. In this embodiment, the drive unit 1 also has a motor 2 with a drive shaft 3. Here, the drive shaft 3 is the motor shaft 14. The motor 2 is shown in FIG. 7 only schematically and without details. Furthermore, the drive unit 1 has a coupling unit 4, which has a rotor element 5, a receiving element 6, a plurality of first coupling bodies 7 and a plurality of second coupling bodies 8. The rotor element 5 is in this embodiment also rotatably connected to the drive shaft 3. The rotor element 5 has six first receiving spaces 9 extending substantially radially to the longitudinal axis L. The first receiving spaces 9 are substantially cylindrical in shape. A cylindrical pin-shaped, first coupling body 7 is inserted in each of three of the first receiving spaces 9. Depending on the rotation of the rotor element 5, the first coupling bodies 7 can move by centrifugal force in the first receiving spaces 9 up to a ring 22 arranged on the rotor element 5. The ring 22 limits the movement of the first coupling bodies 7. In this embodiment, the receiving element 6 has a cylindrical projection 21 on a disk-shaped base body, in which the second coupling bodies 8 are held in a form-fitting manner in second receiving spaces 12.

The second receiving spaces 12 extend substantially parallel to the longitudinal axis L. The first receiving spaces 9 extend radially to the longitudinal axis L.

The projection 21 extends at least partially into the rotor element 5, so that the first coupling bodies 7 can move towards and away from the projection 21. The projection 21 has a cylindrical shape. Each first receiving space 9 has an opening 10 that is open in the direction of the projection 21 or toward the longitudinal axis L, so that the first coupling bodies 7 can rest against the projection 21, in particular on a surface 17, in order to interact magnetically with the second coupling bodies 8 in the projection 21. The surface 17 is the outer circumference of the projection 21. The first coupling bodies 7 are designed here as magnetic pins and the second coupling bodies 8 as pins made of a ferromagnetic material. At low rotational speeds of the coupling unit 4 or of the drive shaft 3, the first coupling bodies 7 rest against the surface 17 of the projection 21 and drag on the surface 17. If the rotational speed is increased, the first coupling bodies 7 are forced radially outwards in the direction of the ring 22 by the centrifugal force in the first receiving spaces 9, so that there is no longer any magnetic interaction between the first and second coupling bodies 7, 8 and the coupling unit 4 can rotate freely. Only when the speeds are reduced again do the first coupling bodies 7 move in the direction of the projection 21 and brake the drive shaft 3 due to the magnetic interaction of the first and second coupling bodies 7. 8.

FIG. 9 shows the receiving element 6 in a side view. The projection 21 is -in particular also according to FIG. 8—arranged off-center, i.e. with a slight offset to the longitudinal axis L, so that the projection 21 reciprocates in the rotor element 5 during a rotation of the rotor element 5. The reciprocation favors a movement of the first coupling bodies 7 within the first receiving spaces 9. In particular, a detachment of the first coupling bodies 7 from the surface 17 is favored at increased rotational speeds, in particular from at least one rotational speed threshold value.

The invention is not limited to the embodiments shown and described, but also includes all embodiments having the same effect in the sense of the invention. It is expressly emphasized that the embodiments are not limited to all features in combination, rather each individual sub-feature may also have inventive significance in isolation from all other sub-features. Furthermore, the invention has not yet been limited to the combination of features defined in claim 1 either, but can also be defined by any other combination of certain features of all the individual features disclosed as a whole. This means that in principle virtually any individual feature of claim 1 can be omitted or replaced by at least one individual feature disclosed elsewhere in the application.

Aspects of the Invention:

1. Drive unit (1), comprising at least one motor (2), at least one drive shaft (3), and at least one coupling unit (4), wherein the coupling unit (4) comprises at least one rotor element (5), at least one receiving element (6), at least one first coupling body (7) and at least one second coupling body (8), wherein the rotor element (5) is rotatable with the drive shaft (3), wherein the first coupling body (7) is arranged on the rotor element (5) in such that at least a radial position of the first coupling body (7) on the rotor element (5) is changeable at least during a rotation, wherein the second coupling body (8) is arranged on the reception element (6), wherein the first coupling body (7) and the second coupling body (8) are designed for magnetic interaction, so that the first coupling body (7) and the second coupling body (8) can magnetically interact at, at least one predetermined radial position of the first coupling body (8) on the rotor element (5) for transmitting a force from the rotor element (5) to the receiving element (6).

2. Drive unit (1) according to aspect 1, characterized in that the radial position is a radial distance to the longitudinal axis, that the first coupling body (7) and the second coupling body (8) interact magnetically, at least if the radial distance (R1) of the first coupling body to the drive shaft (3) corresponds to the radial distance (R2) of the second coupling body (8).

3. Drive unit (1) according to aspect 1 or 2, characterized in that the first coupling body (7) comprises a ferromagnetic material and the second coupling body (8) comprises a permanent magnetic material or that the first coupling body (7) comprises a permanent magnetic material and the second coupling body (8) comprises a ferromagnetic material.

4. Drive unit (1) according to any of aspects 1 to 3, characterized in that a plurality of first coupling bodies (7) are arranged on the rotor element (5) in such a way that the respective radial position (R1) of the first coupling bodies (7) can be changed at least during rotation.

5. Drive unit (1) according to any one of aspects 1 to 4, characterized in that a plurality of second coupling bodies (8) are arranged on the receiving element (5), and in that the second coupling bodies (8) have a common fixed radial distance (R2) from the drive shaft (3) or different fixed radial distances (R2) from the drive shaft (3).

6. Drive unit (1) according to any one of aspects 1 to 5, characterized in that the rotor element (5) has at least one first receiving space (9), and in that the first coupling body (7) is arranged in the first receiving space (9) such that it can move in the radial and/or axial direction.

7. Drive unit (1) according to aspect 6, characterized in that the first receiving space (9) has at least one opening (10) at least in the direction of the receiving element (5) or in the direction of the longitudinal axis (L), so that the first coupling body (7) can abut at least partially against a surface (17) of the receiving element (6), when the first coupling body (7) and the second coupling body (8) interact magnetically.

8. Drive unit (1) according to aspect 7, characterized in that the surface (17) of the receiving element (5) has at least one projection and/or at least one recess for cooperation with the first coupling body (7).

9. Drive unit (1) according to any of aspects 6 to 8, characterized in that a cross section of the first receiving space (9) decreases toward the receiving element (5) in a direction parallel to a longitudinal axis (L) of the drive shaft (3).

10. Drive unit (1) according to any one of aspects 6 to 9, characterized in that the first receiving space (9) has a substantially drop-shaped cross-section orthogonal to a longitudinal axis (L) of the drive shaft (3), and in that the receiving space (9) is arranged such that the cross-section tapers in the direction of the longitudinal axis (L).

11. Drive unit (1) according to aspect 10, characterized in that the drop-shaped cross-section has two flanks (11) converging towards each other, and in that each of these flanks (11) is arranged at an angle (a) to a radial to the longitudinal axis (L).

12. Drive unit (1) according to any one of aspects 1 to 11, characterized in that the rotor element (5) has a plurality of first receiving spaces (9), and in that at least one first coupling body (7) is arranged in each receiving space (9) such that it can move in the axial and/or radial direction.

13. Drive unit (1) according to any one of aspects 1 to 12, characterized in that the receiving element (6) has at least one second receiving space (12), and in that the second receiving space (12) is formed in such that the second receiving space (12) surrounds the second coupling body (8) in a substantially form-fitting manner.

14. Drive unit (1) according to any one of aspects 1 to 13, characterized in that the receiving element (6) has at least one projection (21), and in that the projection (21) extends at least partially into the rotor element (5).

15. Drive unit (1) according to aspect 14, characterized in that the projection (21) is arranged off-center.

16. Drive unit according to any one of aspects 1 to 15, characterized in that the receiving element (6) is held in a rotationally fixed manner, so that the coupling unit (4) can be used as a brake, or in that the receiving element (6) is held rotatably about the longitudinal axis (L) of the drive shaft (3), so that the coupling unit (4) can be used as a clutch.

17. Drive unit according to aspect 16, characterized in that the receiving element (6) is arranged in a retaining housing (13), and that the retaining housing (13) at least partially surrounds the rotor element (5).

18. Drive unit according to any one of aspects 1 to 17, characterized in that the drive shaft (3) is a motor shaft (14) of the motor (2), so that the rotor element (5) is attached to the motor shaft (14).

19. Drive unit according to any one of aspects 1 to 18, characterized in that at least one gearbox (15) is included, that the gearbox (15) is coupled to a motor shaft (14) of the motor, that the gearbox (15) has at least one output shaft (16) and that the driving shaft (3) is the output shaft (16) of the gearbox (15), so that the rotor element (5) is coupled to the output shaft (16).

20. A coupling unit, in particular for a drive unit according to any one of aspects 1 to 19, comprising at least one rotor element (5), at least one receiving element (6), at least one first coupling body (7) and at least one second coupling body (8), wherein the first coupling body (7) is arranged on the rotor element (5) in such a way that at least a radial position of the first coupling body (7) on the rotor element (5) can be changed at least during a rotation, wherein the second coupling body (8) is arranged on the receiving element (6), wherein the first coupling body (7) and the second coupling body (8) are designed for magnetic interaction, so that the first coupling body (7) and the second coupling body (8) can magnetically interact at at least one predetermined radial position of the first coupling body (8) on the rotor element (5) for transmitting a force from the rotor element (5) to the receiving element (6).

### List of Reference Signs

1 Drive unit
2 Motor
2a Housing
3 Drive shaft
4 Coupling unit
5 Rotary element
6 Receiving element
7 First coupling body
8 Second coupling body
9 First receiving space
10 Opening
11 Flanks
12 Second receiving space
13 Retainer housing
14 Motor shaft
15 Gearbox
16 Output shaft
17 Surface
18 Walls
19 Output shaft
20 Receiving housing
21 Projection
22 Ring
L Longitudinal axis
R1 Radial distance from first coupling body 7
R2 Radial distance from second coupling body 8
α Flank angle

1. A drive unit comprising at least one motor, at least one drive shaft, and at least one coupling unit, wherein the coupling unit comprises at least one rotor element, at least one receiving element, at least one first coupling body and at least one second coupling body, wherein the rotor element is rotatable with the drive shaft, wherein the first coupling body is arranged on the rotor element such that at least a radial position of the first coupling body on the rotor element is changeable at least during rotation, wherein the second coupling body is arranged on the receiving element, wherein the first coupling body and the second coupling body are designed for magnetic interaction, so that the first coupling body and the second coupling body can magnetically interact at, at least one predetermined radial position of the first coupling body on the rotor element for transmitting a force from the rotor element to the receiving element.

2. The drive unit according to claim 1, wherein the radial position is a radial distance to the longitudinal axis, that the first coupling body and the second coupling body interact magnetically, at least if the radial distance R1 of the first coupling body to the drive shaft corresponds to the radial distance R2 of the second coupling body.

3. The drive unit according to claim 1, wherein the first coupling body comprises a ferromagnetic material and the second coupling body comprises a permanent magnetic material or that the first coupling body comprises a permanent magnetic material and the second coupling body comprises a ferromagnetic material.

4. The drive unit according to claim 1, wherein a plurality of first coupling bodies are arranged on the rotor element in such a way that the respective radial position of the first coupling bodies can be changed at least during rotation.

5. The drive unit according to claim 1, wherein a plurality of second coupling bodies are arranged on the receiving element, and in that the second coupling bodies have a common fixed radial distance R2 from the drive shaft or different fixed radial distances from the drive shaft.

6. The drive unit according to claim 1, wherein the rotor element has at least one first receiving space, and in that the first coupling body is arranged in the first receiving space such that it can move in the radial and/or axial direction.

7. The drive unit according to claim 6, wherein the first receiving space has at least one opening at least in the direction of the receiving element or in the direction of the longitudinal axis L, so that the first coupling body can at least partially abut against a surface of the receiving element, when the first coupling body and the second coupling body interact magnetically.

8. The drive unit according to claim 7, wherein the surface of the receiving element has at least one projection and/or at least one recess for interaction with the first coupling body.

9. The drive unit according to claim 6, wherein a cross section of the first receiving space decreases towards the receiving element in a direction parallel to a longitudinal axis L of the drive shaft.

10. The drive unit according to claim 6, wherein the first receiving space has a substantially drop-shaped cross-section orthogonal to a longitudinal axis L of the drive shaft, and in that the receiving space is arranged such that the cross-section tapers in the direction of the longitudinal axis L.

11. The drive unit according to claim 10, wherein the drop-shaped cross-section has two flanks converging towards each other, and that each of these flanks is arranged at an angle a to a radial to the longitudinal axis L.

12. The drive unit according to claim 1, wherein the rotor element has a plurality of first receiving spaces, and in that at least one first coupling body is arranged in each receiving space such that it can move in the axial and/or radial direction.

13. The drive unit according to claim 1, wherein the receiving element has at least one second receiving space, and in that the second receiving space is formed such that the second receiving space surrounds the second coupling body in a substantially form-fitting manner.

14. The drive unit according to claim 1, wherein the receiving element has at least one projection, and in that the projection extends at least partially into the rotor element.

15. The drive unit according to claim 14, wherein the projection is arranged off-center.

16. The drive unit according to claim 1, wherein the receiving element is held in a rotationally fixed manner, so that the coupling unit can be used as a brake, or in that the receiving element is held in a rotatable manner about the longitudinal axis L of the drive shaft, so that the coupling unit can be used as a clutch.

17. The drive unit according to claim 16, wherein the receiving element is arranged in a retaining housing, and that the retaining housing at least partially surrounds the rotor element.

18. The drive unit according to claim 1, wherein the drive shaft is a motor shaft of the motor, so that the rotor element is attached to the motor shaft.

19. The drive unit according to claim 1, wherein at least one gearbox is included, that the gearbox is coupled to a motor shaft of the motor, that the gearbox has at least one output shaft and that the drive shaft is the output shaft of the gearbox, so that the rotor element is coupled to the output shaft.

20. A coupling unit, comprising at least one rotor element, at least one receiving element, at least one first coupling body and at least one second coupling body, wherein the first coupling body is arranged on the rotor element in such a way that at least a radial position of the first coupling body on the rotor element can be changed at least during a rotation, wherein the second coupling body is arranged on the receiving element, wherein the first coupling body and the second coupling body are designed for magnetic interaction, so that the first coupling body and the second coupling body can magnetically interact at at least one predetermined radial position of the first coupling body on the rotor element for transmitting a force from the rotor element to the receiving element.
